(19) United States
(12) Patent Application Publication
(10) Pub. No.: US 2008/0174175 A1
(43) Pub. Date: Jul. 24, 2008

(54) Master link for machine track and method

(76) Inventors: Richard E. Livesay, Peoria, IL (US); Faraz Hussain, Peoria, IL (US); Donovan S. Clarke, Hanna City, IL (US); Richard L. Buxton, East Peoria, IL (US); Thomas E. Oertley, Peoria, IL (US); Nishith D. Sanghvi, Edwards, IL (US); Michael Poremski, Morton, IL (US); David A. Lapen, Peoria, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(21) Appl. No.: 11/655,499

(22) Filed: Jan. 19, 2007

(51) Int. Cl. B62D 55/205

(52) U.S. Cl. 305/186

(57) ABSTRACT

A master link for a track of a machine includes a first link member having a profiled surface with a sinusoidal segment defined by a tooth and an adjacent recess. The master link further includes a second link member configured complementarily to the first link member, their respective profiled surfaces together defining a mating interface for transmitting loads therebetween. A machine further includes a track having a single tooth master link wherein profiled surfaces on adjacent link members together define a mating interface for transmitting loads through the track, each of the profiled surfaces having a sinusoidal segment.

### TECHNICAL FIELD

The present disclosure relates generally to master links used in machine tracks, and relates more particularly to a single tooth master link configuration and method wherein profiled sinusoidal surfaces of separate link members of the master link together define a mating interface for transmitting loads through a machine track.

### BACKGROUND

Many types of machines have flexible tracks consisting of a plurality of links coupled together to form a flexible, endless loop. Conveyors, torque transmitting apparatuses and the like, for example, may utilize tracks for transporting materials or for transferring torque between rotating components. Another application for track is providing “traction” for mobile machines operating in certain environments. Mining, construction, forestry, road building and other industries all rely upon machines having ground engaging tracks for performing a variety of important tasks. As with any machine, it is desirable to provide some means for disassembling certain components for servicing or repair. A “master link” is provided in many machine tracks for this purpose, and a great many different designs have been developed over the years.

In one common class of master link designs, one or more teeth are provided on separate link portions, the link portions being mated together such that the teeth interlock with one another. Fasteners such as dowels, bolts, etc. may be used to secure the respective link portions together, and the master link positioned in a machine track where it operates much like any of the other links. When it is desirable to break the track for repair, servicing, shipping, etc., the fasteners coupling the link portions together are removed, allowing the track to be separated via disassembling the link portions. While the basic two-part master link approach has proven to be quite useful, the ruggedness of many environments within which tracked machines operate can mandate specialized features for master links, as well as place a premium on durability and service life.

As mentioned above, interlocking teeth are commonly used to couple together link portions of master links. The number, spacing, orientation, etc. of teeth in multi-piece toothed master link strategies may vary, and engineers have experimented with numerous different designs over the years. It has been discovered that in certain instances, a single tooth design provides a practical strategy, obviating the machining time requirements relating to numerous teeth, as well as having other advantages. A typical “single” tooth design actually has a tooth and pocket on each of its two link portions. The tooth of each link portion fits into the pocket of the other link portion. Fasteners are used to couple the link portions together, often slightly deforming or displacing the components to provide a snug fit and retention of the fasteners themselves.

A problem with many known single tooth and multi-tooth designs relates to the tendency for stress concentrations to be inherent in the components. Particularly where relatively complex geometry and numerous machined surfaces provide the interface between link portions of a master link, relatively sharp corners and other features can serve as stress concentrators. When actually placed in service, stress concentrations within and among the components of a master link can lead to failure after a significantly shorter service life than that of the track itself. In other words, the master link may fail before a desired time for disassembling the track, depending of course on the operating conditions. U.S. Pat. No. 4,457,565 to Bissi et al. is directed to a two-piece master link wherein a contact zone between the link portions includes a long flat, as well as relatively abrupt transitions between sections of the surfaces providing the contact zones. While Bissi et al. purport to have a design wherein all of the mating surfaces between the link portions “adhere” to one another, the design would still be susceptible to stress concentrations that could lead to unexpected failure of the master link under certain circumstances. There is thus a continuing need for improved master link durability and service life.

The present disclosure is directed to one or more of the problems or shortcomings set forth above.

### SUMMARY OF THE INVENTION

In one aspect, the present disclosure provides a master link for a track of a machine. The master link includes a first link member having a first end with a strap, a second end and a profiled surface. The profiled surface includes a first slope transitioning to a second slope via a sinusoidal segment defined by a tooth and an adjacent recess adjoining the first and second slopes, respectively. The master link further includes a second link member also having a first end with a strap, a second end and a second profiled surface which is configured complementarily to the profiled surface of the first link member. The respective profiled surfaces together define a mating interface between the first and second link members for transmitting loads between the first and second link members.

In another aspect, the present disclosure provides a machine having a frame with a plurality of rollers, a track coupled with the frame and including a plurality of links forming an endless chain extending about the rollers. The machine further includes at least one master link including one of the links of the track, the at least one master link having a first link member coupled with a second link member, each of the first and second link members including a profiled surface. The respective profiled surfaces together define a mating interface between the link members for transmitting loads through the track, each of the profiled surfaces including a first slope transitioning to a second slope via a sinusoidal segment defined by a tooth and an adjacent recess adjoining the first and second slopes, respectively.

In still another aspect, the present disclosure provides a method of reacting loads through a track of a machine, including the step of applying a load to a strap of a first link member of a master link in a track of a machine. The method further includes the step of transferring the load to a second link member of the master link via a mating interface between the first and second link members defined by first and second abutting profiled surfaces which each include a first slope transitioning with a second slope via a sinusoidal segment defined by a tooth and an adjacent recess adjoining the first and second slopes, respectively.

### BRIEF DESCRIPTION OF THE DRAWINGS

FIG. 1 is a side view of a machine according to one embodiment;

FIG. 2 is a diagrammatic side view of a master link according to one embodiment;

FIG. 3 is a perspective view of one component of the master link shown in FIG. 2;

FIG. 4 is a perspective view of the master link shown in FIG. 2;

FIG. 5 is a perspective view of another component of the master link shown in FIG. 2;

FIG. 6 is another perspective view of the master link shown in FIG. 2;

FIG. 7 is a diagrammatic side view of a master link according to another embodiment;

FIG. 8 is a top view of the master link shown in FIG. 7; and

FIG. 9 is a perspective view of the master link shown in FIGS. 7 and 8.

### DETAILED DESCRIPTION

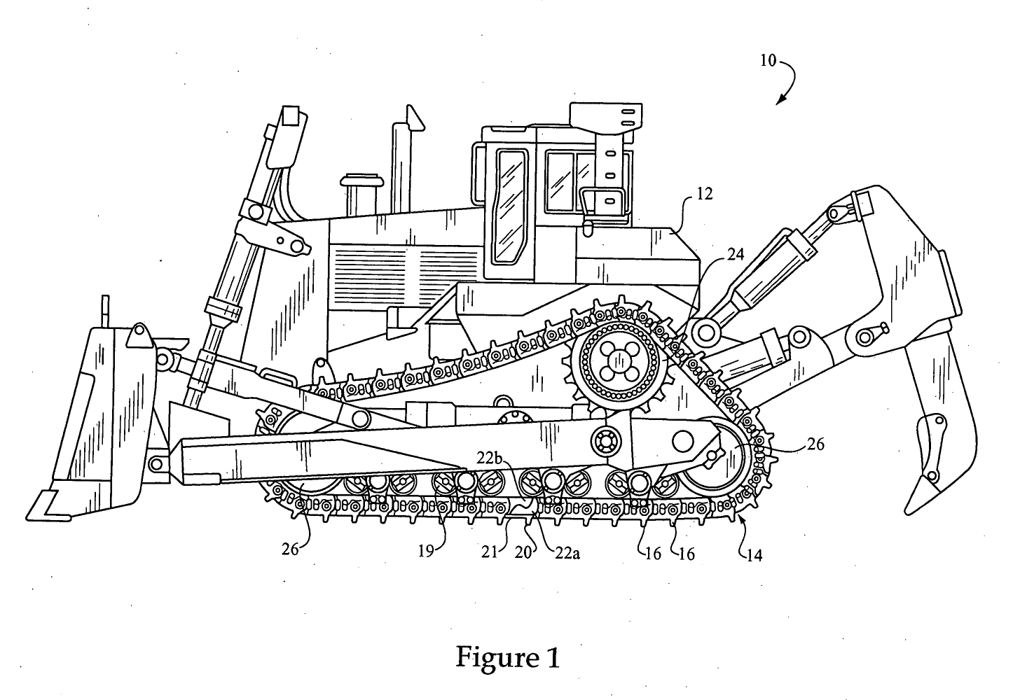

Referring to FIG. 1, there is shown a machine 10 according to one embodiment of the present disclosure. Machine 10 includes a frame 12 having a first track 14 disposed at one side thereof, and a second track (not shown) disposed at the other side thereof. Those skilled in the art will appreciate that the respective tracks of a machine such as machine 10 will typically be identical, and configured to engage the ground for propelling machine 10, thus descriptions herein of track 14 should be understood to refer similarly to the track of machine 10 which is not shown. Track 14 may extend about a plurality of rolling elements such as a drive sprocket 24, a front idler 26 and a rear idler 26, as well as a plurality of conventional track rollers 19. While machine 10 is illustrated in the context of a track-type tractor, it should be appreciated that the present disclosure is not thereby limited, and a wide variety of other machines having tracks are contemplated within the present context. For instance, a conveyor, a track for transmitting torque between rotating elements, and still other applications are contemplated. Further, while tracks of the type commonly used with tractors such as machine 10 will often include dual sets of coupled together links 16, one of which is shown in FIG. 1, the present disclosure is also not thereby limited. In all embodiments, however, machine 10 and track 14 will include a specialized master link 20 configured to enable relatively simple breaking of track 14 for repair of track 14 or other components of machine 10, servicing, shipping, etc., without sacrificing robustness or service life.

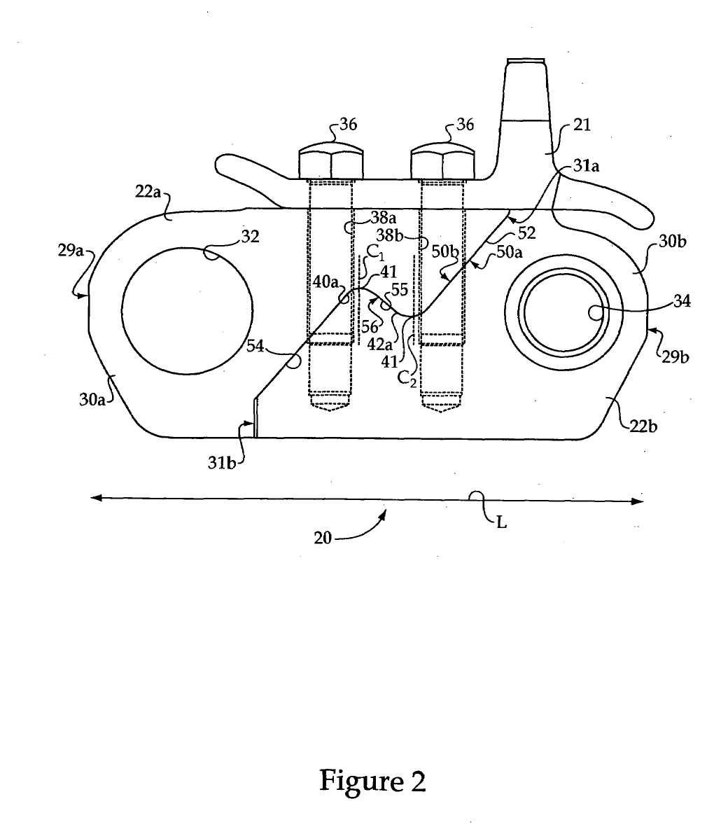

Master link 20 is of the type generally known in the art as a single tooth master link, and may include a first link member 22a and a second link member 22b, each configured to couple with a separate link 16 of track 14. A ground engaging plate 21 may be coupled with one of link members 22a and 22b. Track 14 might include dual sets of coupled together links 16 extending about the respective rollers, each of the sets of links having a master link such as master link 20, although only the outermost of one of these sets of links is shown in FIG. 1. Turning now to FIG. 2, there is shown a side diagrammatic view of master link 20, shown inverted relative to the orientation shown in FIG. 1. Each of link members 22a and 22b may include a first end 29a and 29b, respectively, and a second end 31a and 31b, respectively.

The ends of each of link members 22a and 22b may comprise a strap 30a and 30b which is configured to engage with and support one of a bushing and a pin (neither shown). In the illustrated embodiment, first link member 22a includes a bushing strap 30a whereas second link member 22b includes a pin strap, however, the configuration might be reversed in other embodiments. Bores 32 and 34 may be provided in each of link members 22a and 22b, respectively, for engaging with the corresponding bushing/pin, which in turn facilitate coupling with adjacent links or other track components. It should be appreciated, however, that in other embodiments, some other coupling strategy with adjacent links, or some other track configuration not using bushings or pins and the like may be implemented. In still other embodiments, each set of coupled together links 16 might include a plurality of master links.

A set of two fasteners 36 are provided for coupling link members 22a and 22b together. Fasteners 36 may be positioned within bores 38a and 38b which each extend through link member 22a and partially through link member 22b, the separate portions of bores 38a and 38b in the respective link members being configured to align with one another when link members 22a and 22b are mated together. It may be noted that in the FIG. 2 embodiment, bores 38a and 38b are disposed at different positions relative to a length L, or length dimension, of master link 20. In other embodiments, described herein, bores in separate link members may be disposed side by side at similar positions relative to a length dimension of the respective master link. Fasteners 36 may also be used to secure plate 21 with master link 20. The use of fasteners 36, in conjunction with the further configuration of master link 20 described herein, will allow master link 20 to be assembled and/or disassembled quite readily with simple hand tools, in contrast to certain earlier designs requiring the use of a hydraulic press or the like. As such, field maintenance, repair or servicing may be possible with master link 20 in a manner not practicable in other designs, without sacrificing strength, although it is contemplated that master link 20 may itself have a service life as long as, or longer, than track 14.

Each of link members 22a and 22b may include a profiled surface 50a and 50b, respectively, together defining a mating interface between link members 22a and 22b for transmitting loads between link members 22a and 22b, and consequently for transmitting loads through track 14. The respective profiled surfaces 50a and 50b may have complementary profiles, in other words as illustrated in FIG. 2 their profiles may be substantially mirror images of one another. The footprints of surfaces 50a and 50b may differ somewhat, however, as further described herein. While the following description focuses on profiled surface 50a of link member 22a, it should be understood as referring also to profiled surface 50b of link member 22b, except as otherwise indicated.

Profiled surface 50a may include a first slope 52 extending generally diagonally downward from second end 31a and transitioning to a second slope 54 which may be parallel with first slope 52 and extends generally diagonally upward from the vicinity of strap 30a. Transitioning of first slope 52 to second slope 54 may be via a sinusoidal segment 56 of profiled surface 50a. Sinusoidal segment 56 may be defined by a tooth 42a and a recess 40a of link member 22a. Tooth 42a and recess 40a are adjacent one another, and adjoin first slope 52 and second slope 54, respectively.

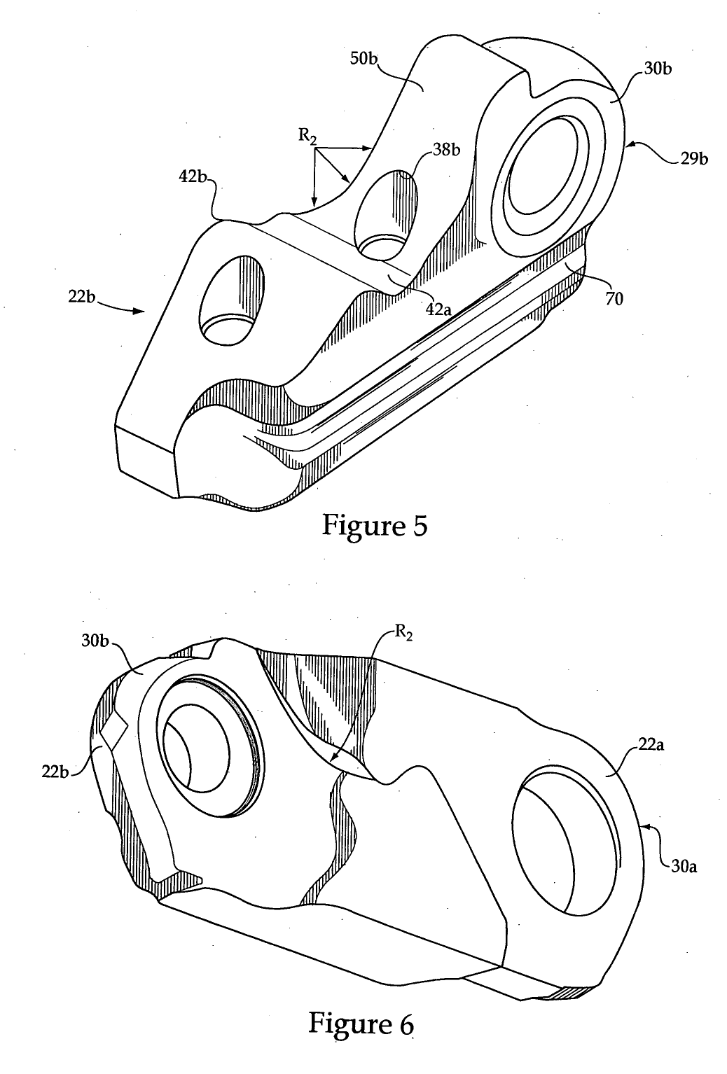

As alluded to above, profiled surfaces 50a and 50b are configured with complementary profiles and define a mating interface between link members 22a and 22b. To achieve a sound coupling between link members 22a and 22b, relatively small spaces 41 may exist between the tooth and recess of one of link members 22a and 22b and the respective recess and tooth of the other one of link members 22a and 22b. Spaces 41 may be symmetrical about centerlines C₁ and C₂. In one practical implementation strategy, bores 38a and 38b may span a relatively small end portion of spaces 41 at approximately a point where the corresponding slope 52, 54 transitions to a radius defined by the adjoining tooth 42a or recess 40a. This has been found to be an optimal positioning for bores 38a and 38b in at least certain embodiments, which tends to be affected by several factors. On the one hand, they cannot be located too close to straps 30a and 30b, nor can they be located too close to one another, as in either case, strength of link members 22a and 22b may be affected. Optimal positioning of bores 38a and 38b is also affected by heat treating of a rail 70, identified in FIG. 5, as tapping bores through heat treated metallic material tends to be difficult given its hardness. Further still, it may be undesirable to position bores 38a and 38b to overlap too much of spaces 41, as doing so can position bores 38a and 38b within the radiuses defined by tooth 42a and recess 40a, removing material that might otherwise be available for distributing stress/strain in master link 20, the significance of which will be apparent from the following description.

Returning to the configuration of profiled surface 50a, as used herein, the term sinusoidal should not be understood to mean that a perfect sine wave is defined by the profile of surface 50a in its sinusoidal segment, however, to achieve certain of the goals of master link 20 profiled surface 50a may have certain characteristics of a sine wave, as further described herein. In one practical implementation strategy, sinusoidal segment 56 may comprise approximately one period of a sine wave, and may comprise less than one period of a sine wave in other embodiments.

Each of tooth 42a and recess 40a may include a vertical centerline C₁ and C₂, as shown in FIG. 2, and may be symmetrical about the respective centerline. Each of tooth 42a and 42b may further define a radius, which are parts of sinusoidal segment 56, each of the radiuses blending with the corresponding adjoining slope 52 and 54, respectively. Sinusoidal segment 56 may include a middle segment 55, having a length which extends approximately between a maximum point of sinusoidal segment 56 and a minimum point of sinusoidal segment 56, the maximum and minimum points lying at an intersection of centerlines C₁ and C₂ with recess 40a and tooth 42a, respectively.

Middle segment 55, which may further include a relatively short flat, may have a profile overlapping with the radiuses defined by tooth 42a and 42b over a majority of its length. In other words, middle segment 55 may consist of a segment of profiled surface 50a which is made up predominantly by portions of profiled surface 50a which follow the radiuses of tooth 42a and recess 40a, any flat portion of middle segment 55 constituting less than a majority of its length. In other contemplated embodiments, no portion of middle segment 55 consists of a flat, and middle segment 55 will overlap the radiuses defined by tooth 42a and recess 40a along its entire length, having an inflection point at a midpoint of its length. Middle segment 55 may be blended with the radiuses defined by tooth 42a and recess 40a, respectively. Controlling the size of any flat portion of middle segment 55 as described allows the size of the radiuses defined by tooth 42a and recess 40a to be maximized, for stress distribution purposes.

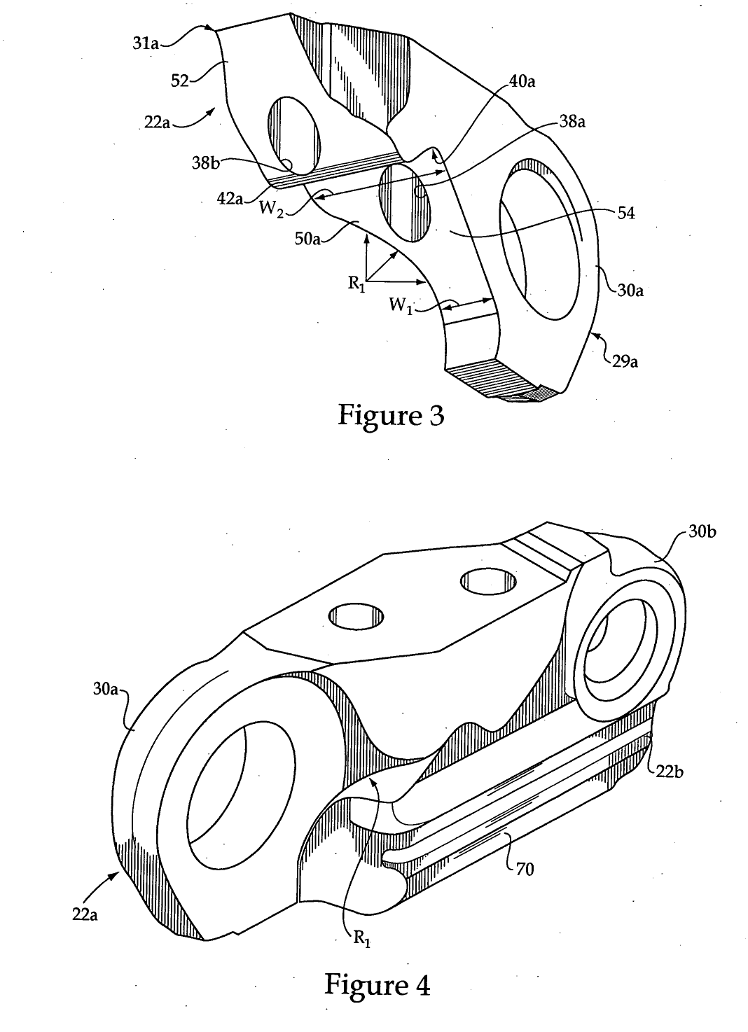

Turning to FIG. 3, there is shown in perspective link member 22a. It will be noted that link member 22a has a non-uniform width. It has been discovered that tailoring the width and/or the footprint of each of the link members 22a and 22b in a particular manner, described herein, can increase the relative strength of master link 20, while keeping the parts relatively easy to manufacture. In some embodiments, the footprints of link members 22a and 22b may include non-overlapping portions. Link member 22a may include a first width W₁ in the general vicinity of strap 30a which transitions to a second, larger width W₂ approximately in the region of bore 38a via a radius R₁. Link member 22b may also include a width in the region of bore 38b which is relatively larger than width W₁. It has further been discovered that maximizing the size of radius R₁ given a thickness/width of link member 22a has an increased stress distributing effect, as compared to relatively smaller radii in other master links having non-uniform widths. Turning also to FIG. 5, there is shown in perspective link member 22b, also having a tooth 42b and recess 40a, and a width that increases generally from the vicinity of strap 30b toward bore 38b via a radius R₂, also maximized in size, given the thickness of link member 22b.

Referring also to FIGS. 5 and 6, there are shown different perspective views of link members 22a and 22b in an assembled configuration. It may be noted from the FIGS. 5 and 6 illustrations in particular that each of link members 22a and 22b is enlarged in thickness in its center in regions around bores 38a and 38b. Moreover, radiuses R₁ and R₂, which define the thickening of link members 22a and 22b in directions away from straps 30a and 30b and toward second ends 31a and 31b, respectively, may provide for a relatively more gradual increase in thickness than that at the opposite ends of link members 22a and 22b.

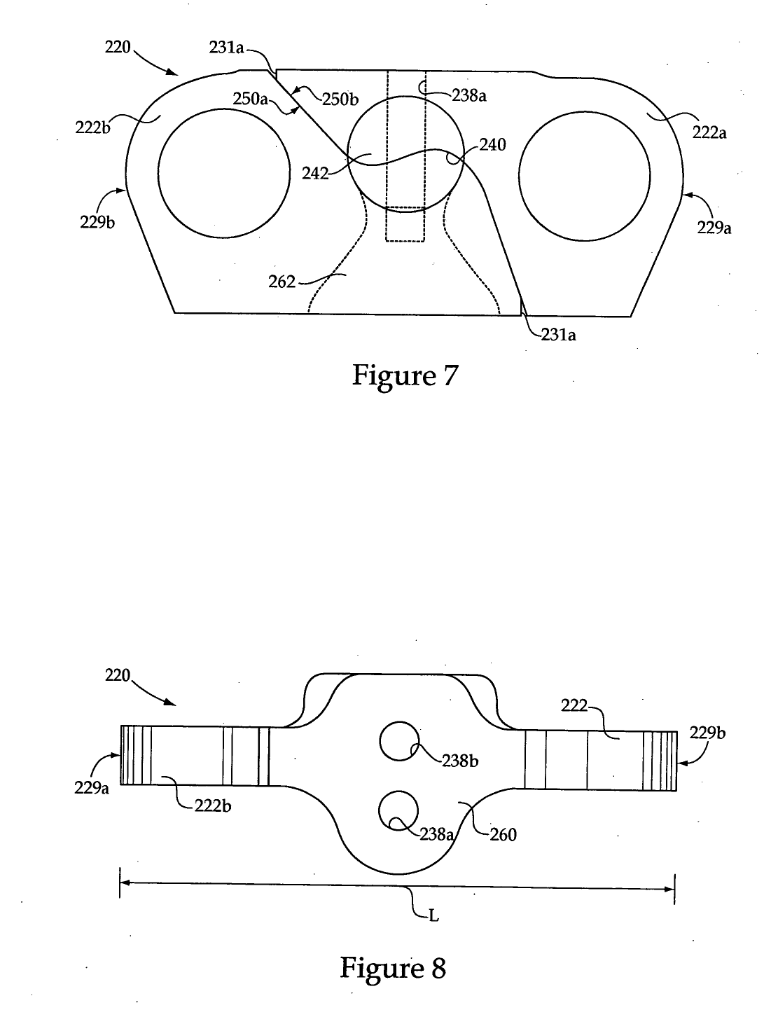

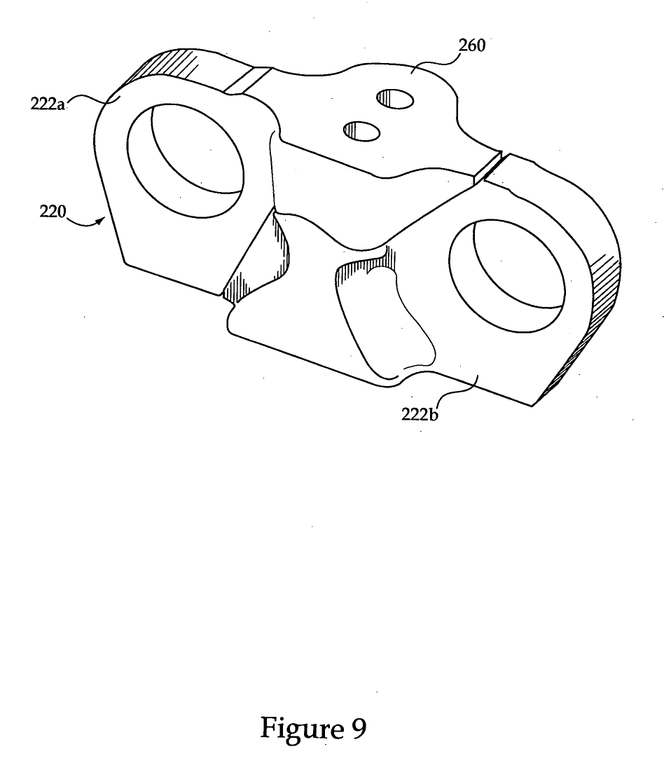

Turning now to FIGS. 7-9, there are shown side, top and perspective views of a master link 220 according to another embodiment of the present disclosure. In the version shown in FIGS. 7-9, similar reference numerals are used to identify features similar to those described with regard to the foregoing embodiments. In particular, master link 220 may include a first link member 222a and a second link member 222b, each having a profiled surface 250a and 250b, respectively, configuring to together provide a mating interface between link members 222a and 222b for transmitting loads between link members 222a and 222b, and thereby transmitting loads through a track wherein master link 220 is used. Each of profiled surfaces 250a and 250b includes sinusoidal segments similar to those of master link 20, but typically including no flat portion at all. First and second link members 222a and 222b each include first ends 229a and 229b, respectively, second ends 231a and 231b, respectively, and bores 238a and 238b, each of bores 238a and 238b being located in part within each link member 222a and 222b. Each of link members 222a and 222b also includes a tooth 242 and recess 240, each defining a radius that comprises approximately one half of the sinusoidal segment of the respective profiled surfaces 250a and 250b.

Master link 220 differs from master link 20, among other things, in that bores 238a and 238b are disposed in a side by side arrangement at the same position relative to a length L of master link 220. In addition, master link 220 includes a side lug 260 defined in part by each of link members 222a and 222b. Side lug 260 protrudes outwardly from master link 220 such that it can be engaged by a toothed rotating member of a track, such as track 14 of machine 10 shown in FIG. 1. A radius matching the tooth in a sprocket may form the top of the lug. A protruding foot 262 may extend down from a center portion 263 to contact a track shoe or the like. In the embodiment shown in FIGS. 7-9, bore 238a may be disposed in side lug 260, whereas the other bore 238b may be disposed in a main body of master link 220. Incorporating lug 260, and thickening of link members 222a and 222b in their centers as shown, provides for a relatively large amount of material about bores 238a and 238b. The radiuses which transition from ends 229a and 229b toward the full width center portion of the link can be relatively larger, at least by a factor of one and one half, than certain earlier designs, further assisting in stress distribution in master link 220.

### INDUSTRIAL APPLICABILITY

Master links 20 and 220 may be suitable for use in a wide variety of tracks, however, it is contemplated they may be best suited to different track types relative to one another. Master link 20 may be used where adjacent track links are coupled together in an alternating arrangement, as will be apparent from the relative offset of straps 30a and 30b from one another. Master link 220, on the other hand, may be best suited to tracks having a different manner of coupling adjacent links together. In any event, the following description of master link 20 should be understood as generally applicable also to master link 220.

Master link 20 may be installed into a track such as track 14 for use by engaging straps 30a and 30b with pins, bushings, etc., and coupling link members 22a and 22b together via fasteners 36 such as bolts. Breaking of track 14 is achieved by loosening fasteners 36 to de-couple link members 22a and 22b, for example with wrenches, etc. Once assembled into track 14, master link 20 will tend to operate similarly to any other track link. For instance, a load applied to one of link members 22a and 22b via a strap 30a, 30b will be transmitted via the abutting profiled surfaces 50a and 50b to the other link member 22a, 22b, and thenceforth to an adjacent track link via the other strap 30a, 30b.

As discussed above, profiled surfaces 50a and 50b, and the other radial surfaces of the respective link members, are configured to distribute strain/stress during loading of master link 20 in a manner superior to known designs. This is achieved in part via sinusoidal segments 56 of the respective profiled surfaces 50a and 50a, and in particular by fashioning the radiuses defined by tooth 42a and recess 40a to be as large as possible. The footprints of each of links members 22a and 22b are also tailored to optimally distribute stress, as described herein. Earlier single tooth designs typically suffer from an inability to optimally distribute strain during loading, as the mating surfaces between the link members either include transitions, e.g. radii, which are too small, unduly concentrating stress, or because slopes in the mating surfaces are too flat, or include too much flat, to permit the radius size to be maximized. In other words, conventional single tooth master links tend to not include smoothly transitioning, symmetrical large radiuses in their abutting surfaces, or in their footprints, a characteristic which the present disclosure now recognizes as desirable in optimally distributing strain during loading. In each of the embodiments described herein, the profiled surfaces 50a, 50b, 150a, 150b, may have a uniform surface finish, at least in their respective sinusoidal segments, as load transmitting between the abutting surfaces is contemplated to be substantially uniform along the sinusoidal segments due to proper sizing, blending, etc. of the radiuses and slopes.

One example of maximizing the size of interfacing surface radiuses is in an embodiment, described above, wherein middle segment 55 of sinusoidal segment 56 overlaps with the radiuses defined by tooth 42a and recess 40a over a majority of its length, or over all of its length. By designing middle segment 55 to have a flat portion which is less than a majority of its length, or nonexistent, the relative size of the respective radiuses may be made larger. In contrast many, if not most, earlier single tooth designs include relatively large flats at the abutting surfaces between the components. The embodiments described herein enable further strain distribution by providing relatively large radiuses in transitioning from a first width of master links 20, 220 near their straps to the relatively greater width in the vicinity of bores 38a, 38b, 238a, 238b. These features all combine to create a master link superior in performance, strength and reliability than earlier designs.

The present description is for illustrative purposes only, and should not be construed to narrow the breadth of the present disclosure in any way. Thus, those skilled in the art will appreciate that various modifications might be made to the presently disclosed embodiments without departing from the intended spirit and scope of the present disclosure. For instance, while embodiment of FIGS. 7-9 includes a side lug and foot, these features need not be included. Embodiments are contemplated wherein side by side bolt bores in a thickened center portion are used without a sprocket-engaging side lug or track shoe-engaging foot. Other aspects, features and advantages will be apparent upon an examination of the attached drawings and appended claims.

What is claimed is:

1. A master link for a track of a machine comprising:
a first link member including a first end having a strap, a second end and a profiled surface, said profiled surface including a first slope transitioning to a second slope via a sinusoidal segment defined by a tooth and an adjacent recess adjoining the first and second slopes, respectively; and
a second link member also including a first end having a strap, a second end and a second profiled surface which is configured complementarily to the profiled surface of said first link member;
wherein the respective profiled surfaces together define a mating interface between said first and second link members for transmitting loads between the first and second link members.

2. The master link of claim 1 wherein the second profiled surface also includes a first slope, a second slope and a sinusoidal segment defined by a tooth and an adjacent recess adjoining its first and second slopes, respectively, and wherein the sinusoidal segments of said profiled surfaces each include a first radius and a second radius defined by the tooth and recess, respectively, of the corresponding link member, each of the radiuses being symmetrical about a vertical centerline of the corresponding tooth and recess.

3. The master link of claim 2 wherein the sinusoidal segment of each of said profiled surfaces further includes a middle segment having a length and extending from a maximum point to a minimum point of the respective sinusoidal segment, each of said middle segments having a profile overlapping with the first and second radiuses of the corresponding sinusoidal segment over a majority of said length.

4. The master link of claim 3 wherein each of said middle segments is blended with the first and second radiuses of the corresponding link member.

5. The master link of claim 2 wherein each of said profiled surfaces includes a non-uniform width and has its first and second slopes blended with the first and second radiuses, respectively, of the corresponding link member, and wherein each of said link members has an enlarged center portion transitioning with the corresponding strap via at least one radius.

6. The master link of claim 5 comprising a length dimension extending between the first end of said first link member and the first end of said second link member;
said first link member including a plurality of bores disposed at different positions relative to said length dimension and configured to receive fasteners therein for coupling said first and second link members together; and
another plurality of bores disposed in said second link member and also configured to receive said fasteners, said another plurality of bores being positioned to align one with each of the plurality of bores in said first link member.

7. The master link of claim 5 comprising a length dimension extending between the first end of said first link member and the first end of said second link member;
said first link member including a set of two bores disposed side by side at similar positions relative to said length dimension and configured to receive fasteners therein for coupling said first and second link members together; and
another plurality of bores disposed in said second link member, said another plurality of bores being configured to receive said fasteners and being positioned to align one with each of the bores of said first link member.

8. The master link of claim 7 further comprising at least one side lug defined in part by said first link member and defined in part by said second link member, said side lug being configured to engage with a toothed rotating member of a machine.

9. A machine comprising:
a frame having a plurality of rollers;
a track coupled with said frame and comprising a plurality of links forming an endless chain extending about said rollers; and
at least one master link comprising one of the links of said track, said at least one master link including a first link member coupled with a second link member, each of said first and second link members including a profiled surface;
wherein the respective profiled surfaces together define a mating interface between the link members for transmitting loads through said track, each of said profiled surfaces including a first slope transitioning to a second slope via a sinusoidal segment defined by a tooth and an adjacent recess adjoining the first and second slopes, respectively.

10. The machine of claim 9 wherein said at least one master link includes a plurality of master links, wherein said track comprises a first ground engaging track positioned at a first side of said frame which includes at least one of said plurality of master links, and wherein said machine further includes a second ground engaging track positioned at a second side of said frame which also includes at least one of said plurality of master links.

11. The machine of claim 10 wherein at least the sinusoidal segment of each of said profiled surfaces includes a uniform surface finish.

12. The machine of claim 11 wherein the sinusoidal segment of each of said profiled surfaces includes a middle segment extending from a maximum point to a minimum point of the respective sinusoidal segment and having a length, each of said middle segments further including a flat constituting less than a majority of its length.

13. The machine of claim 11 wherein the tooth and the recess of each of said link members define a first radius and a second radius, respectively, each of said first and second radiuses being symmetrical about a vertical centerline of the corresponding tooth and recess.

14. The machine of claim 13 further comprising a plurality of fasteners, including first and second fasteners associated with each of said master links, wherein each of said master links includes a plurality of bores each extending within its respective first and second link members and configured to receive the corresponding first and second fasteners for coupling the first and second link members together.

15. The machine of claim 14 wherein each of said link members includes first and second longitudinally spaced bores configured to receive the corresponding first and second fasteners.

16. The machine of claim 14 wherein each of said link members includes first and second bores disposed side by side and configured to receive the corresponding first and second fasteners, said link members each defining a portion of a side lug, and wherein at least one of the rollers of said plurality of rollers includes a plurality of teeth configured to engage about said side lug.

17. A method of reacting loads through a track of a machine comprising the steps of:
applying a load to a strap of a first link member of a master link in a track of a machine; and
transferring the load to a second link member of the master link via a mating interface between the first and second link members defined by first and second abutting profiled surfaces which each include a first slope transitioning with a second slope via a sinusoidal segment defined by a tooth and an adjacent recess adjoining the first and second slopes, respectively.

18. The method of claim 17 wherein the transferring step further includes a step of distributing strain via a plurality of radiuses of the sinusoidal segments defined by each tooth of the first and second link members and by each recess of the first and second link members and being symmetrical about vertical centerlines of the corresponding tooth or recess.

19. The method of claim 18 wherein the distributing step further includes distributing strain via blends between the sinusoidal segments of the profiled surfaces and the first and second slopes of the corresponding link members, the transferring step further comprising maintaining a space between a peak of each tooth and a recess receiving each tooth.

20. The method of claim 19 wherein the distributing step further includes distributing strain via at least one radius of each of said link members, different from the radiuses of the profiled surfaces, which transitions between the strap of the respective link member and an enlarged center portion of the respective link member.
